(19) United States
(12) Patent Application Publication
(10) Pub. No.: US 2007/0137650 A1
(43) Pub. Date: Jun. 21, 2007

(54) Air-purifying breathing apparatus

(76) Inventor: Cham Man Chan, Hong Kong (CN)

Correspondence Address: John Chen;Room 303, 3F., No 25, Sec. 1, Changan E. Road, Taipei, 10441, TW

(21) Appl. No.: 11/371,915

(22) Filed: Mar. 10, 2006

(30) Foreign Application Priority Data
Dec. 15, 2005 (CN) 200510102195.1

(51) Int. Cl. A62B 23/02; A62B 18/08

(52) U.S. Cl. 128/205.27; 128/206.27

(57) ABSTRACT

An air-purifying breathing apparatus is provided. The breathing apparatus comprises an air chamber with a filter disposed therein. The air chamber is directly communicated with a respiratory tract through pipes. Therefore, the air-purifying breathing apparatus has the advantages of completely filtering air; avoiding backflow; and making full use of filtered fresh air. Further, the breathing apparatus is directly communicated with the respiratory tract, thus fitting various facial forms of different people. Moreover, various filter elements can be used, such that the breathing apparatus is applicable to various working and living environments.

### BACKGROUND OF THE INVENTION

1. Field of Invention

The present invention relates to an air purifying and protective apparatus, and more particularly to an air-purifying breathing apparatus adapted to mouth/nose breathing.

2. Description of Related Art

At present, commonly used masks, made of multiple layers of breathable gauze with a cotton layer or filtering layer sandwiched therebetween, cover the mouth and nose together. The gauze layer or the filtering layer is used to filter dust, impurities, deleterious pathogens, or gases in the air before the air is inhaled into the respiratory tract of a human body. However, since the respiratory tract gets too close to the gauze, heat exchange occurs when a person exhales waste air, such that vapor accumulates in the gauze, which causes the gauze stick to the skin adjacent to the respiratory tract. Therefore, masks the gauze of which does not stick to the skin have been designed. For example, a mask disclosed in PRC Patent NO. 96209278.9 comprises a filtering cavity communicating the inside and outside. The mask has two nasal clips for supporting the mask, and covers both the mouth and nose. The filtering material is a sponge containing water. Though the gauze does not stick to the skin, the filtering effect is poor. Meanwhile, since no exhausting apparatus is provided, the waste air exhaled out cannot be exhausted in time, such that the waste air may be inhaled when breathing and a part of the filtered fresh air may be exhausted. Moreover, no adjustable apparatus is provided for fitting various facial forms, thus air leakage will occur due to different facial forms and breathing strengths. Also, an anti-stifle mask is disclosed in PRC Patent NO. 03250805.0, and comprises a mask, an air container, a fixing belt, a sealing ring, and a filtering air lock. However, the air intake space of the filtering block is small, and the filtering material is extremely dense, thus users cannot breathe smoothly. The air container is a barrel-shaped, which affects the visual line and work safety. Meanwhile, the anti-stifle mask also cannot be adjusted according to various facial forms to fit different persons. In U.S. Pat. No. 4,294,243, a mask disclosed comprises a mask and a glass, and further comprises an intake pipe having a front end, and a switch connected to the glass for manually opening and closing, so as to fix the mask over the nose. The mask generally is a dual filtering mask. However, no filtering material is in the suture of the dual filtering mask, so the air inhaled in the respiratory tract cannot be completely filtered. Also, the mask cannot also be adjusted according to individual facial forms. Thus, a breathing mask and releasing mechanism thereof as disclosed in U.S. Pat. No. 6,497,232 was designed. A rubber belt is elastic and adjustable, such that the mask can be pressed close to the face and also can be quickly removed for the user to breathe air outside. However, the rubber belt has a limited stretching and adjusting range and the filtering mask is also the common dual face mask, and thus the air inhaled in the respiratory tract cannot be completely filtered.

### SUMMARY OF THE INVENTION

The object of the present invention is to provide an air-purifying breathing apparatus directly communicated with the respiratory tract without being limited to the facial forms of users and capable of completely filtering air, thus overcoming the defects of the conventional techniques.

In order to achieve the above object, the present invention is realized through the following technical solutions.

The air-purifying breathing apparatus includes an air chamber with a filter disposed therein, and a belt for fixing the apparatus, wherein the air chamber is directly communicated with the respiratory tract through a pipe.

A base for fixing an intake pipe, an outlet pipe, and the filter is further included.

The air chamber is connected with the outlet pipe with soft glue.

The belt comprises a tether strap for fixing the filter, an outlet pipe tightening belt, and an exhaust valve leveling apparatus.

The filter is disposed on one end of the intake pipe. The other end of the intake pipe is communicated with the air chamber. The air chamber is further communicated with the outlet pipe for exhausting air.

The pipe comprises a nozzle communicated with the mouth of the respiratory tract and a nose hose communicated with the nose.

The outlet pipe is provided with a light-press or flat two-way exhaust valve.

The filter comprises a non-closed chamber wall and a filter element placed in the chamber body.

The filter is covered with a rainproof cover. A waterproof cover tightening cap is disposed at the joint of the filter and the intake pipe. A bleeder plug is disposed at the bottom of the intake pipe.

The connection between the chamber wall and the filtering material is sealed in a manner of bonding.

The filter element comprises an outer layer exposed to air and a filter inner core placed behind the outer layer.

The outer layer is a titanium dioxide foam filter screen or a coarse composite terylene fiber filter screen.

The filter inner core comprises a fine composite terylene fiber layer, an active carbon layer wrapped by the fiber layer, a fine composite fiber layer or a nanometer material layer in order.

A soft gasket is disposed between the filter inner core and the wall of the intake pipe.

The filter inner core is an epidemic preventing element made of multi-layer composite terylene fiber or nanometer filtering material.

A hardened washer is disposed between the epidemic preventing element and the outer layer for support.

Through the above technical solution, the present invention has the following advantages.

Air can be completely filtered.

The backflow can be prevented completely.

The filtered fresh air can be completely used.

The apparatus of the present invention is directly communicated with the respiratory tract, and thus it will not be limited to various facial forms of different people.

Various filter elements can be used to fit various working and living environments.

### BRIEF DESCRIPTION OF THE DRAWINGS

FIG. 1 is a schematic view of an air-purifying breathing apparatus according to the present invention.

FIG. 2 is a schematic view of the air-purifying breathing apparatus provided with a base according to the present invention.

FIG. 3 is a schematic side view of the air-purifying breathing apparatus in operation according to the present invention.

FIG. 4 is a sectional view of the air-purifying breathing apparatus filter containing an ordinary filter element according to the present invention.

FIG. 5 is a schematic view of the two-way exhaust valve in the intake pipe of the air-purifying breathing apparatus according to the present invention.

FIG. 6 is a sectional view of the air-purifying breathing apparatus filter containing a heavy and super large filter element according to the present invention.

FIG. 7 is a schematic view of an air-purifying breathing apparatus according to the second embodiment of the present invention.

FIG. 8 is a schematic side view of the air-purifying breathing apparatus in operation according to the second embodiment of the present invention.

### DESCRIPTION OF EMBODIMENTS

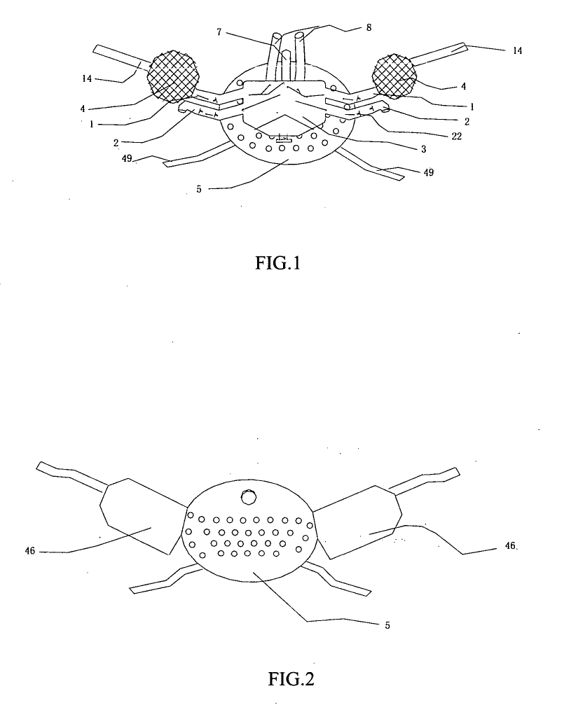

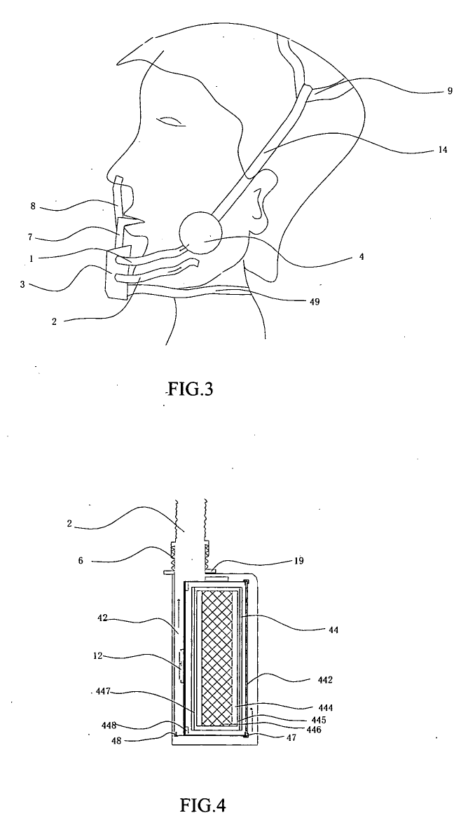

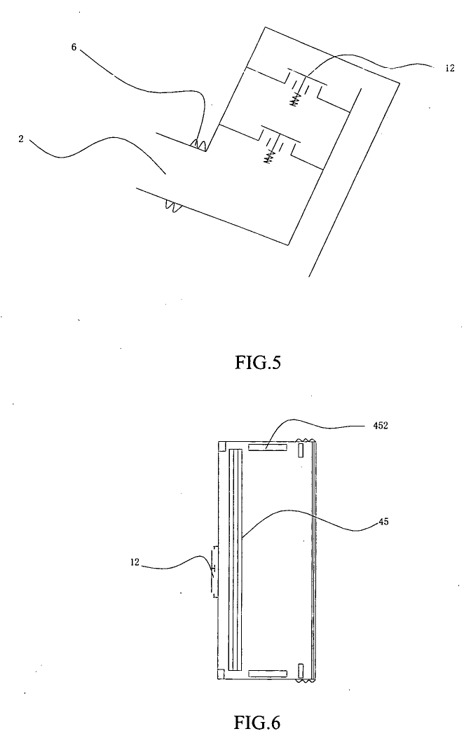

The present invention Will be further described accompanied with drawings. As shown in FIG. 1 to FIG. 6, the air-purifying breathing apparatus comprises an air chamber 3 communicated with the intake pipe 1 and the outlet pipe 2. A filter 4 for filtering the air entering the intake pipe can be disposed at the end of the intake pipe 1. The air chamber is communicated with the mouth and nose of the respiratory tract through pipes. The breathing apparatus further comprises a base 5 for fixing the intake pipe 1, the outlet pipe 2, and the filter 4. The air chamber is connected with the outlet pipe with soft glue 6, so as to adjust the outlet pipe to be in a level state no matter whether the user is on his/her back or standing up, such that the air can be exhausted smoothly. Moreover, the pipe communicated with the mouth and nose of the respiratory tract comprises a nozzle 7 communicated with the mouth and a nose hose 8 communicated with the nose. The outlet pipe 2 is further provided with a two-way exhaust valve 22 with a spring disposed at the bottom thereof. When exhaling air, the valve is closed under the outside force of exhaling air and the gravity of the spring, such that the exhaled air is exhausted along the outlet pipe and is completely prevented from flowing back. The filter 4 comprises a non-closed chamber wall 42 and a filter element 44 placed inside the chamber body. The connection between the chamber wall and the filter element is in a manner of bonding, such that air without being filtered can be avoided to enter the air chamber from the edges not covered by filtering materials. Thus, it is guaranteed that the air entering into the air chamber is completely filtered, without entering from the suture. The filter element 44 comprises an outer layer 442 exposed to air and a filter inner core 444 placed behind the outer layer, and has the advantages of preventing dust, gas, foreign flavors, and organic gases, and the inner core therein can be replaced. The outer layer 442 is a titanium dioxide foam filter screen or a coarse composite terylene fiber filter screen. The filter inner core 444 includes a fine composite terylene fiber layer 445, an active carbon layer 446 wrapped by the fiber layer, a fine composite fiber layer 447 or a nanometer material layer in order. A soft gasket 448 is disposed between the filter inner core and the wall of the intake pipe. Of course, the filter inner core is a heavy and super large epidemic preventing element 45 made of multi-layer composite fine terylene fiber or nanometer filtering material. Thus, the apparatus can be used when injecting oil, in the desert, and when polishing jewels. As shown in FIG. 6, a hardened washer 452 can be further disposed between the epidemic preventing element and the outer layer for support. Furthermore, the filter 4 can be covered by a rainproof cover 46. A waterproof cover tightening cap 47 is disposed at the joint of the filter 4 and the intake pipe 1, such that the filtering is not affected when the breathing apparatus is used in the rain. Moreover, a bleeder plug 48 is further disposed at the bottom of the intake pipe. When water accumulates after a long period of use, the bleeder plug can be screwed off to keep the interior of the outlet pipe substantially dry. A tether strap 49 for fixing the filter and a outlet pipe tightening belt 14 are further disposed, such that the filter and the entire breathing apparatus can be hung at any suitable position of the human body as desired, thus reducing the load on the face. When using, the air is filtered after passing through the filter element in the filter, thus removing the impurities, dust, bacterium, and the like. After that, the air enters into the air chamber through the intake pipe. As the air chamber is directly communicated with the respiratory tract, the fresh and safe air may enter into the human body through the respiratory tract. When exhaling, under the push of the exhaled air, the two-way exhaust valve of the outlet pipe is pushed aside, such that the waste air exhaled from the human body can be exhausted. Under this circumstance, the air intake and air exhaustion are achieved with the hose pipe communicated with the respiratory tract, and are thus not affected by various facial forms and state of the face and larynx.

In view of the above, compared with the conventional technology, the present invention filters has the advantages of completely filtering air; avoiding backflow; making full use of the filtered fresh air; not being affected by various facial forms of different people because the apparatus is directly communicated with the respiratory tract; and employing various filter elements and being applicable to various working and living environments.

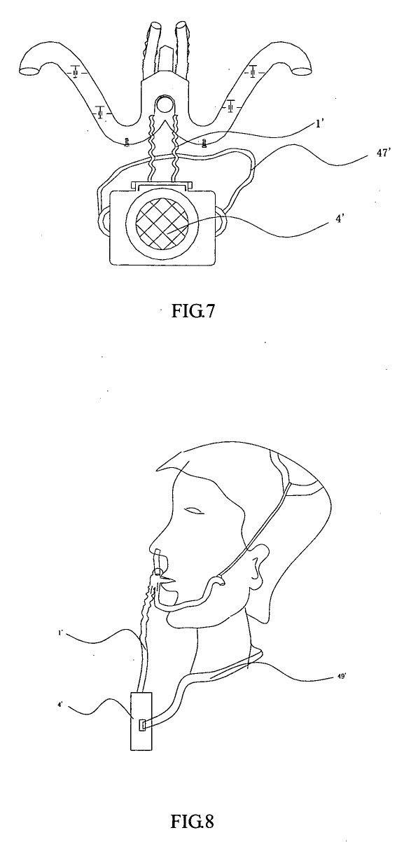

FIG. 7 and FIG. 8 show the second embodiment of the present invention. Different from the first embodiment, a filter 4′ is hung on the neck or other suitable places of the body with a tether strap 49′. An intake pipe 1′ is an elastic hose pipe, such that the filter can be hung on the neck without influencing the usage. Similarly, compared with the conventional technology, the present invention filters has the advantages of completely filtering air; avoiding backflow; making full use of the filtered fresh air; not being affected by various facial forms of different people because the apparatus is directly communicated with the respiratory tract; and employing various filter elements and being applicable to various working and living environments

Of course, the filter element therein can also be replaced to be adapted to the field of spray painting and the like. The apparatus of the present invention can be connected with the oxygen bottles used in hospitals as a respirator after removing the filter element, which can significantly save oxygen and meanwhile completely prevent the air outside from flowing back. Similarly, it is not affected by the features such as individual facial forms and larynxes.

What is claimed is:

1. An air-purifying breathing apparatus, comprising an air chamber with a filter disposed therein, wherein the air chamber is directly communicated with a respiratory tract through pipes.

2. The air-purifying breathing apparatus as claimed in claim 1, further comprising a base for fixing an intake pipe, an outlet pipe, and a filter, and a belt for fixing the apparatus.

3. The air-purifying breathing apparatus as claimed in claim 1, wherein the filter is disposed on one side of the intake pipe, and the other end of the intake pipe is communicated with the air chamber, and the air chamber is communicated with the outlet pipe for exhausting air.

4. The air-purifying breathing apparatus as claimed in claim 1, wherein the air chamber is connected with the outlet pipe through soft glue.

5. The air-purifying breathing apparatus as claimed in claim 2, wherein the belt comprises a tether strap for fixing the filter, an outlet pipe tightening belt, and an exhaust valve leveling device.

6. The air-purifying breathing apparatus as claimed in claim 1, wherein the pipe comprises a nozzle communicated with the mouth of the respiratory tract and a nose hose communicated with the nose.

7. The air-purifying breathing apparatus as claimed in claim 1, wherein the outlet pipe is provided with a light-press or flat two-way exhaust valve.

8. The air-purifying breathing apparatus as claimed in claim 1, wherein the filter comprises a non-closed chamber wall and a filter element placed in a chamber body.

9. The air-purifying breathing apparatus as claimed in claim 8, wherein the filter is covered with a rainproof cover, a waterproof cover tightening cap is disposed at the joint of the filter and the intake pipe, and a bleeder plug is disposed at the bottom of the intake pipe.

10. The air-purifying breathing apparatus as claimed in claim 8, wherein the joint of the chamber wall and the filtering material is sealed in a manner of bonding.

11. The air-purifying breathing apparatus as claimed in claim 8, wherein the filter element comprises an outer layer exposed to air and a filter inner core placed behind the outer layer.

12. The air-purifying breathing apparatus as claimed in claim 11, wherein the outer layer is a titanium dioxide foam filter screen or a coarse composite terylene fiber filter screen.

13. The air-purifing breathing apparatus as claimed in claim 11, wherein the filter inner core comprises a fine composite terylene fiber layer, an active carbon layer wrapped by the fiber layer, a fine composite fiber layer or a nanometer material layer in order.

14. The air-purifying breathing apparatus as claimed in claim 11, wherein a soft gasket is disposed between the filter inner core and the wall of the intake pipe.

15. The air-purifying breathing apparatus as claimed in claim 10, wherein the filter inner core is an epidemic preventing element made of multi-layer composite terylene fiber or nanometer filtering material.

16. The air-purifying breathing apparatus as claimed in claim 15, wherein a hardened washer is disposed between the epidemic preventing element and the outer layer for support.
